(19) United States
(12) Patent Application Publication
(10) Pub. No.: US 2004/0252772 A1
(43) Pub. Date: Dec. 16, 2004

(54) Filter bank based signal processing

(76) Inventors: Markku Renfors, Tampere (FI); Tero Ihalainen, Tampere (FI); Tobias Hidalgo-Stitz, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/335,544

(22) Filed: Dec. 31, 2002

(51) Int. Cl. H04K 1/00; H04B 1/69

(52) U.S. Cl. 375/260

(57) ABSTRACT

The invention relates to a method for a filter bank based signal processing system. In order to enable a signal processing with a low complexity and at the same time a good performance, a method is proposed which comprises in a first step performing a filter-bank based analysis for converting a complex higher-rate channel signal into oversampled lower-rate sub-channel signals, each sub-channel corresponding to a different frequency range. In a second step, the proposed method comprises processing the oversampled lower-rate sub-channel signals with a polynomial model of a system frequency response within the frequency range of the respective sub-channel. The invention relates equally to a unit and a system comprising means for realizing the proposed method.

### FIELD OF THE INVENTION

The invention relates to a method for a filter bank based signal processing system. The invention relates equally to a unit performing a signal processing in a filter bank m based signal processing system and to a filter bank based signal processing system comprising such a unit.

### BACKGROUND OF THE INVENTION

Processing signals comprises in a variety of systems a channel equalization. A channel equalization is employed for compensating the effects of a fading multipath channel, which constitute a fundamental problem in communication systems.

Various channel equalization techniques have been developed for the traditional single-carrier transmission systems and more recent CDMA systems. With increasing data rates and signal bandwidths in new and future systems, there is moreover an increasing interest in multicarrier transmission techniques, for which dedicated channel equalization techniques have to be employed. In a multicarrier transmission system, a transmitted higher-rate data stream is divided into a number of lower-rate sub-channels partly overlapping in the frequency domain. For multiplexing and demultiplexing these sub-channels, various techniques are known, for instance orthogonal Frequency Division Multiplexing (OFDM) techniques and filter bank based multicarrier (FBMC) techniques. FBMC techniques are sometimes also referred to as Discrete Wavelet Multitone (DWMT) techniques.

OFDM has been described for example by R. van Nee and R. Prasad in chapter 2 “OFDM basics” of the document “OFDM Wireless Multimedia Communications”, Artech House, London, 2000. In an OFDM system and its baseband version Discrete Multitone (DMT), a high-rate datastream is split into a number of lower rate streams that are transmitted simultaneously over a number of sub-carriers, in order to decrease the relative amount of dispersion in time caused by multipath delay spread. The sub-channels are multiplexed and demultiplexed by means of an IFFT-FFT (Inverse Fast Fourier Transform/Fast Fourier Transform) pair. In OFDM and DMT systems, a time-domain guard interval introduced for every OFDM symbol and a simple 1-tap frequency domain equalization is commonly used for channel equalization. In the guard time, the OFDM symbol is cyclically extended to avoid intercarrier interference.

OFDM and DMT systems are very robust from a channel equalization point of view. On the other hand, there are certain advantages that can be obtained by using an FBMC system instead of an IFFT-FFT pair, as will be explained in the following.

An FBMC system has been presented for example by T. Ihalainen, Tobias Hidalgo-Stitz and Markku Renfors in: “On the performance of low-complexity ASCET-equalizer for a complex transmultiplexer in wireless mobile channel” in Proc. 7th Int. OFDM-Workshop 2002, Harburg, Germany, pp. 122-126, Sep. 2002, which is incorporated by reference herein.

FIG. 1 is a block diagram of a 0^{th} order ASCET (Adaptive sine-modulated/cosine-modulated filter bank equalizers for transmultiplexers) equalizer structure for complex systems, which was taken from the above cited document “On the performance of low-complexity ASCET-equalizer for a complex transmultiplexer in wireless mobile channel”. The system comprises a transmitting end and a receiving end, between which a multicarrier radio communication is to be enabled.

In order to achieve a good spectral efficiency in radio communications, it is necessary to have a complex I/Q baseband model for the FBMC system. The equalizer structure of FIG. 1 therefore comprises at the transmitting end a synthesis bank for converting 2M real low-rate sub-channel signals for transmission into a complex I/Q (In phase/Quadrature) presentation of a high-rate channel signal. The sampling rate conversion factor is M. The synthesis filter bank includes a cosine modulated filter bank (CMFB) 10, in which sub-filters are formed by modulating a real low-pass prototype filter with a cosine sequence. The cosine-modulation translates the frequency response of the prototype filter around a new center frequency. The synthesis filter bank moreover comprises a sine modulated filter bank (SMFB) 11, in which corresponding sub-filters are formed by modulating a real low-pass prototype filter with a sine sequence.

The equalizer structure further comprises at the receiving end an analysis bank for converting a received high-rate channel signal into low rate sub-channel signals again. A complex critically sampled perfect reconstruction (PR) analysis bank would equally include a corresponding CMFB and a corresponding SMFB, which take the real part of the signal after the complex sub-channel filtering. The prototype filter can be optimized in such a manner that the filter bank satisfies the PR condition, i.e. the analysis transform is invertible by the synthesis transform. In the structure of FIG. 1, however, the analysis bank implements a filter bank with complex output signals instead of real output signals by employing two CMFBs 12, 14 and two SMFBs 13, 15. This way, oversampled sub-channel signals can be obtained for enabling a channel equalization.

The exact equations realized by the CMFBs 10, 12, 14 and the SMFBs 11, 13, 15 can be taken from the above cited document “On the performance of low-complexity ASCET-equalizer for a complex transmultiplexer in wireless mobile channel”.

For a transmission, 2M low-rate symbol sequences, which are to be transmitted on a respective sub-channel, are fed to the synthesis filter bank of the transmitting end, half of them corresponding to sub-channels between 0 and fₛ/2, and the other half corresponding to sub-channels between 0 and −fₛ/2, where fₛ is the high sampling rate. More specifically, the difference between a respective pair of symbols Iₖ(m) and I_{2M-1-k}(m) is divided by two and fed to the CMFB 10, while the sum of the respective pair of symbols Iₖ(m) and I_{2M-1-k}(m) is divided by two and fed to the SMFB 11. In the notation Iₖ(m) and I_{2M-1-k}(m), the indices indicate the respective sub-channel, while the parameter m is a time index. The output of the SMFB 11 is multiplied by j and then combined with the output of the CMFB 10 in order to form a complex I/Q channel signal for transmission. The multiplication by j means that the signal output by the SMFB 11 is used as the quadrature component in the subsequent processing. The units required for the described processing at the transmitting end, including summing means, multiplication means, the CMBF 10 and the SMBF 11, will also be referred to as synthesis portion 20, which is indicated in FIG. 1 by a first rectangle with dashed lines.

The radio channel used for transmission is equivalent to a low-pass channel Hₗₚ(z).

At the receiving end, the high-rate channel signal is separated again into a real part Re{.} and an imaginary part Im{.}, the real part Re{.} being fed to the first CMFB 12 and the first SMFB 13 of the analysis bank, and the imaginary part Im{.} being fed to the second CMFB 14 and the second SMFB 15 of the analysis bank. Each of the CMFBs 12, 14 and the SMFBs 13, 15 outputs M signals via M sub-filters.

Each output signal of the second SMFB 15 is subtracted from the corresponding output signal of the first CMFB 12, resulting in a first group of signals, which constitute an in-phase component of the first M sub-channel signals. Each output of the second CMFB 14 is added to the corresponding output of the first SMFB 13, resulting in a second group of signals, which constitute a quadrature component of the first M sub-channel signals. Each output of the second CMFB 14 is subtracted from the corresponding output of the first SMFB 13, resulting in a third group of signals, which constitute a quadrature component of the second M sub-channel signals. Each output of the first CMFB 12 is subtracted from the inverted corresponding output of the second SMFB 15, resulting in a fourth group of signals, which constitute an in-phase component of the second M sub-channel signals. The units required for the processing at the receiving end described so far, including separation means, the CMBFs 12, 14, the SMBFs 13, 15 and summing means, will also be referred to as analysis portion 21, which is indicated in FIG. 1 by a second rectangle with dashed lines.

For channel equalization, a dedicated single real coefficient Cₖ, Sₖ, C_{2M-1-k}, S_{2M-1-k} is then used for weighting the in-phase component and the quadrature component of each sub-channel signal in order to adjust the amplitude and phase of each sub-channel by a simple multiplication. The indices k, 2M-1-k indicate the sub-channel to which the respective coefficient is associated. The coefficients Cₖ, Sₖ, C_{2M-1-k}, S_{2M-1-k} provided for a sub-channel are preferably related to the channel response within the corresponding sub-channel bandwidth.

It is mentioned in the above cited document “On the performance of low-complexity ASCET-equalizer for a complex transmultiplexer in wireless mobile channel” that such a constant coefficient works well only in the case when the frequency response is rather flat within each sub-channel bandwidth, which may require a relatively high number of sub-channels. It is further indicated that higher-order ASCETs may be obtained by including low-order Finite Impulse Response (FIR) filter stages for each of the sub-channels. Such an approach, in which FIR filters are used as equalizers which are adjusted using common adaptation algorithms and criteria, like a mean-squared error criterion, has been described for example by B. Hirosaki in “An analysis of automatic equalizers for orthogonally multiplexed QAM systems,” IEEE Trans. Commun., vol. 28, pp. 73-83, Jan. 1980.

The real parts of corresponding weighted signals of the first and the second group of sub-channel signals are then taken at a respective unit 16 provided to this end and subjected to a respective decision device 18, a so called slicer, in order to obtain the first M real sub-channel symbol sequences Îₖ(m). The real parts of corresponding weighted signals of the third and the fourth group of sub-channel signals are equally taken at a respective unit 17 provided to this end and subjected to a respective slicer 19, in order to obtain the second M real sub-channel symbol sequences Î_{2M-1-k}(m).

The main characteristic of FBMC systems is that the sub-channels can be designed optimally in the frequency domain, e.g. to have good spectral containment. There are certain advantages that can be obtained by using filter banks with highly frequency selective sub-channels in the transmultiplexer configuration instead of an IFFT-FFT pair, as in the case of OFDM and DMT systems.

Firstly, the bank selectivity is a design parameter for precise spectrum control. This provides resistance against narrowband interference and allows the use of very narrow guard bands around the multicarrier signal. Secondly, the guard period applied in OFDM-systems to combat intersymbol interference (ISI) becomes unnecessary. Reducing the frequency-domain guard-band and avoiding the time-domain guard interval saves significant amount of bandwidth for data transmission, thus improving the spectral efficiency. Furthermore, an FBMC system with a proper channel equalization allows the use of a considerably lower number of sub-carriers than the OFDM techniques. This helps to reduce the problems in OFDM which are due to a high peak-to-average power ratio. Being able to use fewer sub-channels to cover the user signal band helps to reduce the latency of the transmission link, improves the performance in case of time-selective channels due to a reduced symbol length, reduces the sensitivity to Doppler effects, frequency errors and phase noise, and gives more freedom in choosing the essential system parameters.

However, the known channel equalization solutions for FBMC systems, in which case the guard-interval approach cannot be used, suffer from insufficient performance, as in the case of the presented 0^{th} order ASCET and/or from relatively high implementation complexity, as in the case of an FIR based approach.

Another structure using a filter bank system which relies on an efficient sub-band processing is the analysis-synthesis (AS) filter bank configuration. In an AS configuration, which can be employed for various coding and adaptive signal processing applications, the signal frequency band is divided in an analysis bank into a number of overlapping sub-bands for processing, and after processing the signal is restored in a synthesis bank by combining the sub-band signals again. In perfect-reconstruction systems, the filter bank design is such that the original signal can be restored completely, if no processing is done in between. In most applications, the system performance can be improved by increasing the number of sub-bands. However, increasing the number of sub-bands increases the implementation complexity, as well as the processing latency due to the filter banks.

The use of the AS configuration in channel equalization in single-carrier systems has been dealt with for example by D. Falconer et al. in “Frequency domain equalization for single-carrier broadband wireless systems”, IEEE Communications Magazine, vol. 40, no. 4, April 2002, pp. 58-66.

### SUMMARY OF THE INVENTION

It is an object of the invention to enable a signal processing in a filter bank based signal processing system which requires a low complexity and which provides at the same time a good performance. It is in particular an object of the invention to enable a signal processing which compensates an undesired distortion of signals in the system.

A method for a filter bank based signal processing system is proposed, which comprises in a first step performing a filter-bank based analysis for converting a complex higher-rate channel signal into oversampled lower-rate sub-channel signals, each sub-channel corresponding to a different frequency range. The proposed method comprises in a second step processing the oversampled lower-rate sub-channel signals with a polynomial model of a system frequency response within the frequency range of the respective sub-channel.

Further, a unit for performing a signal processing in a filter bank based signal processing system is proposed. This unit comprises an analysis filter-bank with a plurality of sub-channel filters for converting a complex higher-rate channel signal input to the unit into oversampled lower-rate sub-channel signals, each sub-channel corresponding to a different frequency range. In addition the proposed unit comprises a filter structure for processing oversampled lower-rate sub-channel signals with a polynomial model of a system frequency response within the frequency range of the respective sub-channel.

Finally, a filter bank based signal processing system is proposed which comprises the proposed unit.

The invention proceeds from the idea that a simplified model for the system frequency response within each sub-channel bandwidth can be on the one hand much closer to the real system frequency response than the piece-wise constant frequency response model, and on the other hand less complex than an accurate model for the system frequency response. Therefore, it is proposed to use an oversampled analysis bank and to model the relevant spectrum or frequency response using a polynomial model in the frequency range of each sub-band as basis for a sub-channel processing.

It is an advantage of the invention that it provides a low-complexity solution with good performance for a sub-channel processing, e.g. a channel equalization, while maintaining at the same time the advantages of sub-band based signal processing techniques utilizing nearly or fully perfect reconstruction filter banks.

For the special case of a channel equalization, for example, the invention allows to approximate the ideal frequency response model with good performance using a considerably lower number of sub-bands than a 0^{th} order equalizer, in which amplitude and phase are assumed to be constant within each sub-band. In comparison to other FBMC approaches with higher-order equalizers, the used polynomial frequency response model reduces the complexity and/or improves the performance of the channel estimation block by reducing the number of parameters that are to be estimated. In case of a direct adaptive equalization, the invention moreover improves the convergence speed. The invention thus provides in general a better tradeoff between performance and complexity than the known channel equalization methods for FBMC systems.

For realizing the oversampling filter bank analysis, the filter bank preferably comprises sine-modulated and cosine-modulated filter bank sections. Further preferably, the analysis is two times oversampled and provides output signals in complex I/Q format. It is to be noted, however, that the invention can be employed for higher oversampling factors as well.

Advantageously, the polynomial model employed for sub-channel processing is a low-order polynomial model, which comprises amplitude and phase response models of a respective sub-band.

The polynomial model can comprise in particular a linearly frequency dependent model for the amplitude response and a linearly frequency dependent model for the phase responses within each sub-channel frequency band. Alternatively, other low-order polynomial models for amplitude and phase responses can be used, for instance 2^{nd} order or 3^{rd} order polynomial models. The models can also be piece-wise linear or low-order polynomial models for real and imaginary parts of the system frequency response.

The sub-channel processing can be realized for example for each sub-band with an amplitude equalizer and an all-pass filter as phase equalizer.

The invention can be employed as well in analysis-synthesis (AS) filter bank configurations as in synthesis-analysis filter bank configurations for transmultiplexers (TMUX).

In case the invention is implemented for a TMUX configuration, for example the TMUX configuration described above with reference to FIG. 1, it may provide a low-complexity solution for the channel equalization in FBMC systems, if the sub-channel processing according to the invention forms part of the channel equalization.

AS configurations are employed for example for transform-domain adaptive signal processing techniques, like adaptive equalizers, for interference cancellers or for system identification tasks. Frequency-domain equalization in single-carrier transmission systems is one particular example of interest. In general, the invention provides a better quality with a given number of sub-channels than the existing approaches because the system is able to model better the ideal frequency response. Alternatively, for given performance requirements, it is possible to reduce the number of sub-bands, which helps to reduce the implementation complexity, as well as the processing latency, which may become critical in many applications. The AS configuration may be employed in particular in a channel equalization in a single carrier transmission system, in which the sub-channel processing according to the invention forms part of the channel equalization. An AS configuration according to the invention may be used in many other signal processing applications as well, though.

The method of the invention can be realized for instance with a signal processing algorithm, e.g. a channel equalization algorithm. Such an algorithm can be implemented for example as a digital VLSI (Very Large Scale Integration) circuit or by using a DSP (Digital Signal Processing) processor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a block diagram of a known 0^{th} order ASCET equalizer structure; and

FIG. 2 is a schematic block diagram of an embodiment of the system according to the invention.

### DETAILED DESCRIPTION OF THE INVENTION

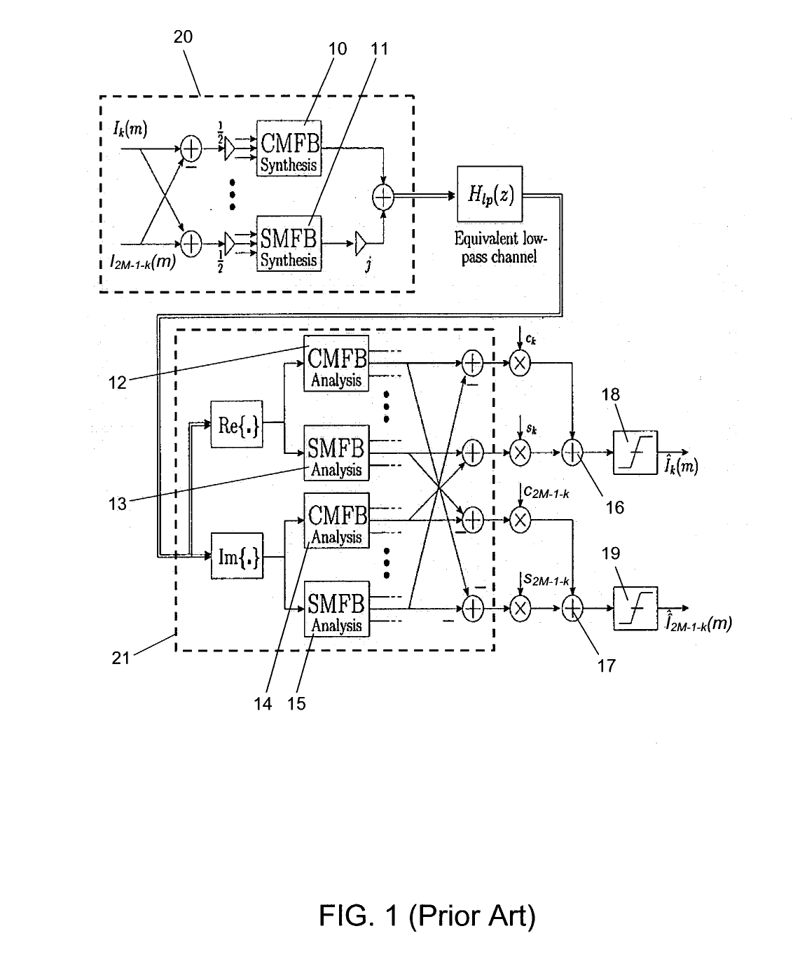

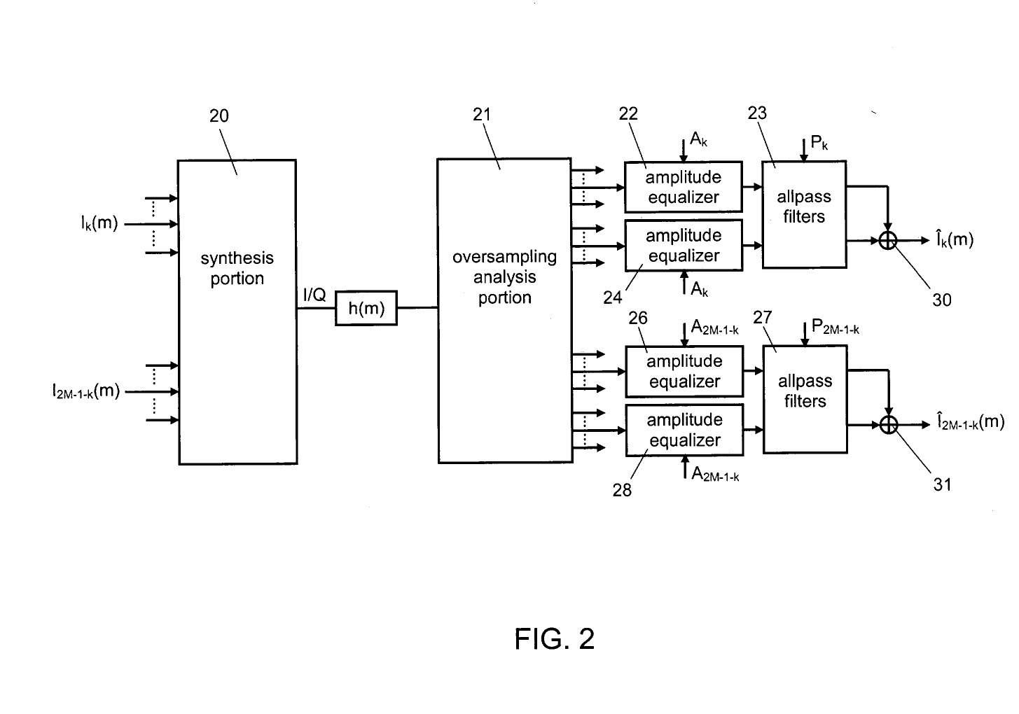

The system illustrated in FIG. 1 was already described above. An embodiment of the system according to the invention, which is an enhancement of the system of FIG. 1, will now be described with reference to FIG. 2.

The system of FIG. 2 comprises a transmitter and a receiver between which multicarrier signals are to be transmitted via the radio interface. The system of FIG. 2 utilizes to this end a filter bank structure which is based on sine-modulated and cosine-modulated filter bank sections in a transmultiplexer configuration. The equalization scheme realized in this embodiment is called AP-ASCET (Amplitude-Phase Adaptive sine-modulated/cosine-modulated filter bank equalizers for transmultiplexers).

The transmitter of the system of FIG. 2 includes a synthesis portion 20 with a synthesis bank. The synthesis bank comprises for 2M input low-rate sub-channel signals a dedicated up-conversion section with a conversion factor of M and a processing function fₖ(m), which constitutes the impulse response for a sub-channel filtering of a particular sub-channel. The index k of the function f indicates the respective sub-channel for which the function is provided, while the parameter m is a time index. The synthesis bank may, but does not have to be structured and operated exactly like the synthesis bank 10, 11 of FIG. 1.

The receiver of the system of FIG. 2 includes an analysis portion 21 with an analysis bank. The analysis bank comprises for each of the 2M sub-channels a cosine-based processing function g_{c}^{k}(m) followed by a down-conversion section with a conversion factor of M, outputting a respective in-phase signal. The analysis bank further comprises for each of the 2M sub-channels a sine-based processing function gₛ^{k}(m) followed by a down-conversion section with a conversion factor of M, outputting a respective quadrature signal. The indices k indicate again a respective sub-channel, while the parameter m is a time index. The analysis bank in the analysis portion 21 is implemented in the two-times oversampled form by taking the output signals in complex I/Q format. Oversampling makes it possible to perform the channel equalization within each sub-channel independently of the other sub-channels, since it enables a per-carrier equalization. A typical case with 100% roll-off, or lower, is assumed in the filter bank design so that the sub-band frequency range is twice the sub-band spacing and that two times oversampling is sufficient to keep all unwanted aliasing signal components below a level determined by the stopband attenuation. The analysis bank may, but does not have to be structured and operated exactly like the analysis bank 12-15 of FIG. 1.

In contrast to the system of FIG. 1, the I and Q outputs of the analysis portion 21 of FIG. 2 are connected for each of the sub-channels to a dedicated special filter structure. Each filter structure comprises a amplitude equalizer 22, 26 connected to the I output of the analysis portion 21 for a specific sub-channel and a amplitude equalizer 24, 28 connected to the Q output of the analysis portion 21 for a specific sub-channel. Each amplitude equalizer 22, 24, 26, 28 constitutes a three-tap real, antisymmetric FIR filter as linear phase amplitude correction stage. Each filter structure further comprises an allpass filter 23, 27 functioning as a phase equalizer for each sub-channel. The outputs of the two amplitude equalizers 22/24, 26/28 associated to a respective sub-channel are connected to two inputs of the allpass filter 23, 27 associated to this sub-channel. The allpass filters 23, 27 may comprise in particular a cascade of two complex allpass phase correction stages and a phase rotation portion. Regardless of whether a single allpass phase correction stage or two allpass phase correction stages are used for each allpass filter 23, 27, first-order complex allpass phase correction stages are employed in order to achieve a good performance. The filter structure can be realized by hardware or software. The two outputs of a respective allpass filter 23, 27 are connected to a unit 30, 31 taking the real part of provided signals.

The filter structure comprises a combination of amplitude and phase equalizers, in order to be able to compensate Inter-Carrier- and Inter-Symbol-Interference. Non-ideal channels cause phase distortions, resulting in a rotation between real- and imaginary branches, and thus causing Inter-Carrier-Interference, while Inter-Symbol-Interference is caused mainly by amplitude distortion.

For a transmission, 2M low-rate symbol sequences Iₖ(m), I_{2M-1-k}(m), which are to be transmitted on sub-channels k, 2M-1-k, are fed to the synthesis filter bank of the transmitting end, half of them corresponding to sub-channels between 0 and fₛ/2, and the other half corresponding to sub-channels between 0 and −f/2, where fₛ is the high sampling rate. In the notation Iₖ(m), I_{2M-1-k}(m), the indices k, 2M-1-k indicate again a respective sub-channel, while the parameter m is a time index. The 2M sub-channel symbol sequences Iₖ(m), I_{2M-1-k}(m) are processed in the synthesis portion 20, transmitted via the radio interface, where they undergo a channel distortion h(m), the parameter m being again a time index, received by the receiver and processed by the analysis portion 21, e.g. as described above with reference to FIG. 1. The sub-channels k and 2M-1-k, which are located symmetrically with respect to the zero-frequency in the baseband model, are equally located symmetrically with respect to the radio frequency carrier frequency in the modulated signals.

The analysis portion outputs for each of the 2M sub-channels an in-phase component and a quadrature component, e.g. like in the system of FIG. 1 signals of a first, second, third and fourth group of low-rate sub-channel signals. The subsequent channel equalization, however, is not realized as in the system of FIG. 1 simply by multiplying the output of each sub-band filter with a fixed complex coefficient cₖ, sₖ.

For the channel equalization in the system of FIG. 2, a linearly frequency-dependent amplitude model Aₖ, A_{2M-1-k} is provided to each of the amplitude equalizers 22, 24, 26, 28, and a linearly frequency-dependant phase model Pₖ, P_{2M-1-k} is provided to each of the allpass filters 23, 27. The respective index k, 2M-1-k of the models indicates the sub-channel to which the filter structure is associated and to which the respective models are provided. It is to be noted that while separate amplitude equalizer can be implemented for the I and Q branches of a respective sub-channel by including the same real filter in the I and Q branches, the phase equalization by the allpass filters involves both I and Q signals, thus a shared allpass filter is provided for the I and Q branches of a respective sub-channel. The phase equalizer part realized by the allpass filters includes also a complex coefficient. Each amplitude model comprises the value of the amplitude of the channel response at the center frequency of the respective sub-channel and the slope of the amplitude. Each phase model comprises the value of the phase of the channel response at the center frequency of the respective sub-channel and the slope of the phase. Thus, four parameters which define the frequency characteristics within each sub-channel are provided to a respective filter structure.

The four parameters are provided to each filter structure by a channel estimation block of the receiver (not shown). The channel estimation block determines the parameters based on known pilot signals transmitted in all or some of the sub-channels from the transmitter to the receiver. Alternatively, a so-called blind method could be employed for determining the parameters, which would not require pilot signals.

It is to be noted that while a linear frequency dependent model is proposed here, a 2^{nd} order model, e.g. in the form a₀+a₁*x+a₂*x², or a 3^{rd} order model, e.g. in the form a₀+a₁*x+a₂*x²+a₃*x³, could be employed as well, where a₀, a₁, a₂ and a₃ are parameters provided for the frequency range of a respective sub-channel and where x constitutes e.g. the deviation of the frequency within this frequency range from the center frequency of this sub-channel.

Based on the received parameters, the filter structures compensate in each signal output by the analysis portion 21 the effects of fading and frequency selectivity in the respective sub-channel on the radio interface.

After this channel equalization, the real part of the in-phase component and the quadrature component of a respective signal are taken at a unit 30, 31 and subjected to a respective slicer (not shown), in order to obtain the restored 2M sub-channel symbol sequences Îₖ(m), Î_{2M-1-k}(m). In the notation Îₖ(m), Î_{2M-1-k}(m), the indices k, 2M-1-k indicate again the respective sub-channel, while the parameter m is again a time index.

Simulation results indicate that using such a piece-wise linearly frequency dependent model for the channel frequency response in channel equalization along with the proposed equalizer structure, a considerable reduction in the number of sub-channels of up to a factor of about 10 is possible in comparison to the basic OFDM systems.

Compared to the 0^{th} order ASCET of FIG. 1, the proposed system has a better performance for a given number of sub-channels, or enables a reduction of sub-channels for a given performance, since the channel response of a sub-channel is not assumed to be a constant value. Compared to known higher-order ASCETs, the proposed system is less complex, since a simplified model is used for the channel response.

It has to be noted that there are various possibilities to order the components of the filter structure and the units taking the real part. The ordering can be done without effecting the overall response. Still, the best order from the implementation point of view would probably be to arrange the complex allpass phase correction stages closest to the analysis portion, followed by a phase rotation by a complex multiplier combined with taking the real part, i.e. calculating only the real part of the output, and finally an amplitude equalizer for the real signal.

While there have shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for a filter bank based signal processing system, said method comprising:
performing a filter-bank based analysis for converting a complex higher-rate channel signal into oversampled lower-rate sub-channel signals, each sub-channel corresponding to a different frequency range; and
processing oversampled lower-rate sub-channel signals with a polynomial model of a system frequency response within the frequency range of the respective sub-channel.

2. The method according to claim 1, wherein sine-modulated and cosine-modulated filter-bank sections are employed for realising said oversampling filter-bank based analysis.

3. The method according to claim 1, wherein said analysis is oversampling two times and provides output signals in in-phase and quadrature (I/Q) format.

4. The method according to claim 1, wherein at least one of said polynomial models of a system frequency response within the frequency range of a respective sub-channel is a linear frequency-dependent model.

5. The method according to claim 1, wherein each of said polynomial models is of an order between 1 and 3.

6. The method according to claim 1, wherein at least one of said polynomial models of a system frequency response within the frequency range of a respective sub-channel is composed of different polynomial models of a system frequency response for different sub-frequency ranges.

7. The method according to claim 1, wherein at least one of said polynomial models of a system frequency response within the frequency range of a respective sub-channel comprises an amplitude response model and a phase response model for said sub-channel.

8. The method according to claim 7, wherein said sub-channel processing is realized with a filter structure comprising for each sub-channel at least one amplitude equalizer using said amplitude response model for the respective sub-channel and an allpass filter using said phase response model for the respective sub-channel.

9. The method according to claim 7, comprising for each sub-channel in this order: performing based on said phase response model for the respective sub-channel a complex allpass phase correction and a phase rotation, in which phase rotation only the real part of an output signal is calculated, and applying based on said amplitude model for the respective sub-channel an amplitude equalization on said output real signal.

10. The method according to claim 1, employed in a transmultiplexer configuration, in which a filter-bank based synthesis is employed for converting lower rate sub-channel signals into said complex higher-rate channel signals.

11. The method according to claim 10, in which said transmultiplexer configuration is used in a channel equalization in a filter bank based multicarrier system, wherein said sub-channel processing forms part of said channel equalization.

12. The method according to claim 1, employed in an analysis-synthesis configuration, in which a filter-bank based synthesis is employed for converting said lower-rate sub-channel signals on which said sub-channel processing was performed into complex higher-rate channel signals.

13. The method according to claim 12, in which said analysis-synthesis configuration is used in a channel equalization in a single carrier transmission system, wherein said sub-channel processing forms part of said channel equalization.

14. A unit for performing a signal processing in a filter bank based signal processing system, said unit comprising:
an analysis filter-bank with a plurality of sub-channel filters for converting a complex higher-rate channel signal input to said unit into oversampled lower-rate sub-channel signals, each sub-channel corresponding to a different frequency range; and
a filter structure for processing oversampled lower-rate sub-channel signals with a polynomial model of a system frequency response within the frequency range of the respective sub-channel.

15. The unit according to claim 14, wherein said analysis filter-bank comprises sine-modulated and cosine-modulated filter-bank sections for realising said oversampling.

16. The unit according to claim 14, wherein said analysis filter-bank realizes a double oversampling and provides output signals in in-phase and quadrature (I/Q) format.

17. The unit according to claim 14, wherein said filter structure employs at least one polynomial model of a system frequency response within the frequency range of a respective sub-channel which is a linear frequency-dependent model.

18. The unit according to claim 14, wherein the respective polynomial model employed by said filter structure is of an order between 1 and 3.

19. The unit according to claim 14, wherein said filter structure employs at least one polynomial model of a system frequency response within the frequency range of a respective sub-channel which is composed of different polynomial models of a system frequency response for different sub-frequency ranges.

20. The unit according to claim 14, wherein said filter structure employs at least one polynomial model of a system frequency response within the frequency range of a respective sub-channel which comprises an amplitude response model and a phase response model for said sub-channel.

21. The unit according to claim 18, wherein said filter structure comprises for each sub-channel at least one amplitude equalizer using said amplitude response model for the respective sub-channel and an allpass filter using said phase response model for the respective sub-channel.

22. The unit according to claim 20, wherein said filter structure comprises for each sub-channel in the following order: an allpass section filtering received signals based on said phase response model for the respective sub-channel, a phase rotation portion rotating the phase of signals output by said allpass phase equalizer based on said phase response model for the respective sub-channel, which phase rotation portion calculates only the real part of said phase rotated signals, and an amplitude equalizer performing an amplitude equalization on real signals provided by said phase rotation portion based on said amplitude response model for the respective sub-channel.

23. The unit according to claim 14, wherein said unit is a receiver for a transmultiplexer system.

24. The unit according to claim 23, which is used in a channel equalization in a filter bank based multicarrier system, wherein said filter structure performs said sub-channel processing as part of said channel equalization.

25. The unit according to claim 14, wherein said unit is a conversion unit for an analysis-synthesis filter bank system.

26. The unit according to claim 25, which is used in a channel equalization in a single carrier transmission system, wherein said filter structure performs said sub-channel processing as part of said channel equalization.

27. A filter bank based signal processing system comprising a unit for performing a signal processing with:
an analysis filter-bank with a plurality of sub-channel filters for converting a complex higher-rate channel signal input to said unit into oversampled lower-rate sub-channel signals, each sub-channel corresponding to a different frequency range; and
a filter structure for processing oversampled lower-rate sub-channel signals with a polynomial model of a system frequency response within the frequency range of the respective sub-channel.

28. The filter bank based signal processing system according to claim 27, wherein said unit is a receiver and wherein said filter bank based signal processing system is a transmultiplexer system further comprising a synthesis filter-bank for converting lower-rate sub-channel signals into complex higher-rate channel signals for transmission to said receiver.

29. The filter bank based signal processing system according to claim 27, wherein said system is an analysis-synthesis filter bank based signal processing system further comprising a synthesis filter-bank for converting lower-rate sub-channel signals on which said sub-channel processing was performed by said unit into complex higher-rate channel signals.
